(19) United States
(12) Patent Application Publication
(10) Pub. No.: US 2008/0005486 A1
(43) Pub. Date: Jan. 3, 2008

(54) Coordination of snoop responses in a multi-processor system

(76) Inventors: Phanindra K. Mannava, Folsom, CA (US); Vivek Garg, Folsom, CA (US)

Correspondence Address: BLAKELY SOKOLOFF TAYLOR & ZAFMAN, 1279 OAKMEAD PARKWAY, SUNNYVALE, CA, 94085-4040, US

(21) Appl. No.: 11/480,096

(22) Filed: Jun. 29, 2006

(51) Int. Cl. G06F 13/28

(52) U.S. Cl. 711/146

(57) ABSTRACT

A request for a block of data from a processor is detected with a node controller. The node controller operates as a single point of interaction to represent a subset of processors in a multi-processor system to one or more remote processors in the multi-processor system. The node controller determines whether the block of data corresponds to an entry in a snoop filter maintained by the node controller. The snoop filter stores indications for a plurality of blocks of data stored in one or more cache memories corresponding to the subset of processors. The node controller sends a dummy snoop request to the requesting processor if the block of data corresponds to an entry in the snoop filter.

### TECHNICAL FIELD

Embodiments of the invention relate to multi-processor systems. More particularly, embodiments of the invention relate to coordination and improved efficiency of snoop requests and responses.

### BACKGROUND

In multi-processor computing systems each processor may have one or more caches available to temporarily store data. In order to ensure valid data, a mechanism for providing cache coherency must be provided. Various techniques are known in the art to provide cache coherency.

As the number of processors increases, the interconnection of processors may be accomplished by using groups of processors, which also may be referred to as clusters of nodes. The groups/clusters may communicate to support cache coherency. In order to provide cache coherency throughout the multi-processor system, modifications to data must be communicated so that data used by a processor is valid data. However, as the number of processors in a system increases so too does the complexity of cache coherency.

### BRIEF DESCRIPTION OF THE DRAWINGS

Embodiments of the invention are illustrated by way of example, and not by way of limitation, in the figures of the accompanying drawings in which like reference numerals refer to similar elements.

FIG. 1 is a block diagram of a group of nodes interconnected with a node controller.

FIG. 2 is a block diagram of one embodiment of an apparatus for a physical interconnect.

FIG. 3 is a conceptual illustration of a technique to resolve a Buried HitM condition.

FIG. 4 is a conceptual illustration of a technique to resolve a Buried HitM condition when two processors request the data.

FIG. 5 is a conceptual illustration of a technique to resolve a Buried HitM condition when a conflicting request is received from a remote node controller.

FIG. 6 is a block diagram of a hierarchical system having multiple node controllers.

### DETAILED DESCRIPTION

In the following description, numerous specific details are set forth. However, embodiments of the invention may be practiced without these specific details. In other instances, well-known circuits, structures and techniques have not been shown in detail in order not to obscure the understanding of this description.

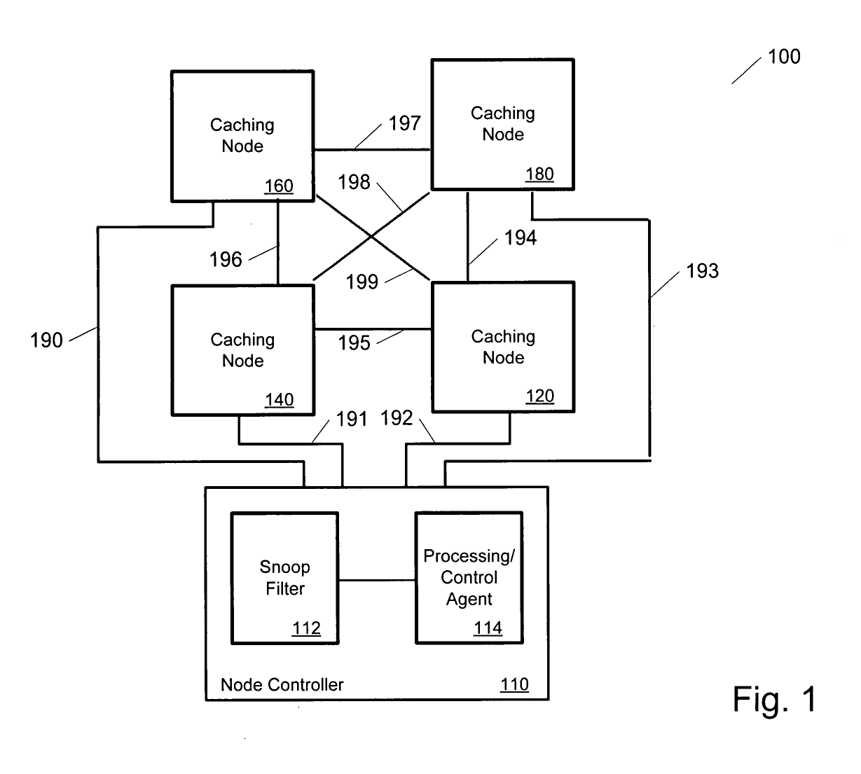

FIG. 1 is a block diagram of a group of nodes interconnected with a node controller. The example of FIG. 1 includes four caching nodes and a single node controller. However, any number of caching nodes may be coupled with a single node controller. The caching nodes and corresponding node controller may be referred to as a “cluster” that may be a part of a larger system.

The four caching nodes (120, 140, 160 and 180) may be any type of system component having a cache memory, for example, a processor. In one embodiment, the caching nodes and node controller may be interconnected via multiple point-to-point links (90, 191, 192, 193, 194, 195, 196, 197, 198, and 199).

In one embodiment, node controller 110 may include snoop filter 112 and processing/control agent 114. Node controller 110 may also include additional circuits and functionality. In one embodiment, node controller 110 may be a gateway for communication beyond the cluster. Node controller 110 may also operate as a proxy home or caching agent for cluster agents, if any. Node controller 110 may also serve as a proxy for the caching agents in the local cluster.

In one embodiment, snoop filter 112 may be a table or other type of tracking mechanism having the ability to track data stored in the caches of cluster 100. Snoop filer 112 may be any type of structure that provides this tracking functionality. As described in greater detail below, snoop filter 112 may allow node controller 110 to direct requests to nodes of cluster 100 rather than requesting data from nodes outside the cluster if snoop filter 112 indicates that the data is available within cluster 100. Various techniques to accomplish this are described herein.

Circumstances may arise where a caching node may have requested data available in one of its caches; yet request the data from other nodes. For example, if caching node 160 requests a block of data, a first operation (e.g., a prefetch) may be to check a second level (L2) cache to determine whether the requested block of data is stored in the cache.

It is possible for the caching node to generate a read request if the data is not in the L2 cache even if the requested block of data is in a different cache level of the caching node. The data may be referred to as “Buried-M” data because the modified (i.e., “M”) data block is buried in the cache structure of the requesting caching node and the resulting condition may referred to as a “Buried HitM” condition. As used herein, “HitM” refers to a condition in which a caching agent responds to a snoop request with a hit to a modified (“M”) line. When an external snoop hits a Buried-M block of data, the extracted data cannot be forwarded to the snoop owner because the snooped node has a request to memory pending. The result of the cache miss and the corresponding read request may be an inefficient use of system resources.

As described herein, the Buried HitM condition may be resolved through use of a conflict message referred to herein as a “RspCnfltOwn” message. In one embodiment, upon receiving a RspCnfltOwn message, node controller 110 may prioritize the request from the sender of the RspCnfltOwn message over all others. That is the caching node with the buried data is selected as the winner from all the conflicting requesters.

In one embodiment, processing/control agent 114 may access snoop filter 112 to determine whether a Buried HitM condition exists. Processing/control agent 114 may provide the functionality of node controller 110 and may be implemented as hardware, software, firmware or any combination thereof.

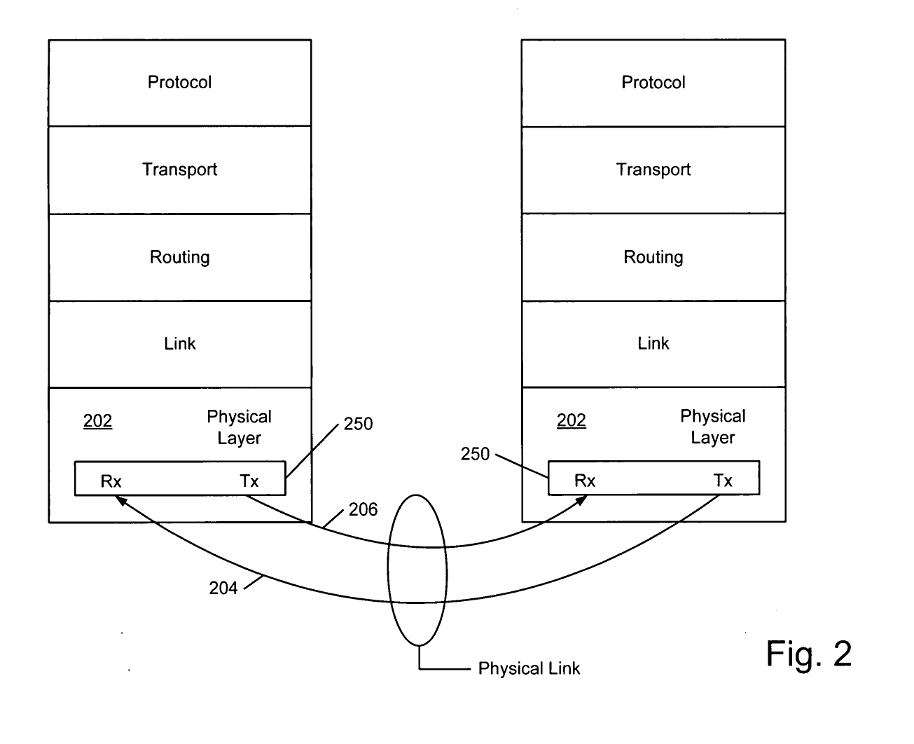

FIG. 2 is a block diagram of one embodiment of an apparatus for a physical interconnect. In one aspect, the apparatus depicts a physical layer for a cache-coherent, link-based interconnect scheme for a processor, chipset, and/or IO bridge components. For example, the physical interconnect may be performed by each physical layer of an integrated device. One or more of the links of FIG. 1 (190, 191, 192, 193, 194, 195, 196, 197, 198, 199) may be implemented as illustrated in FIG. 2.

Specifically, the physical layer may provide communication between two ports over a physical interconnect comprising two uni-directional links. Specifically, one uni-directional link 204 from a first transmit port 250 of a first integrated device to a first receiver port 250 of a second integrated device. Likewise, a second uni-directional link 206 from a first transmit port 250 of the second integrated device to a first receiver port 250 of the first integrated device. However, the claimed subject matter is not limited to two uni-directional links.

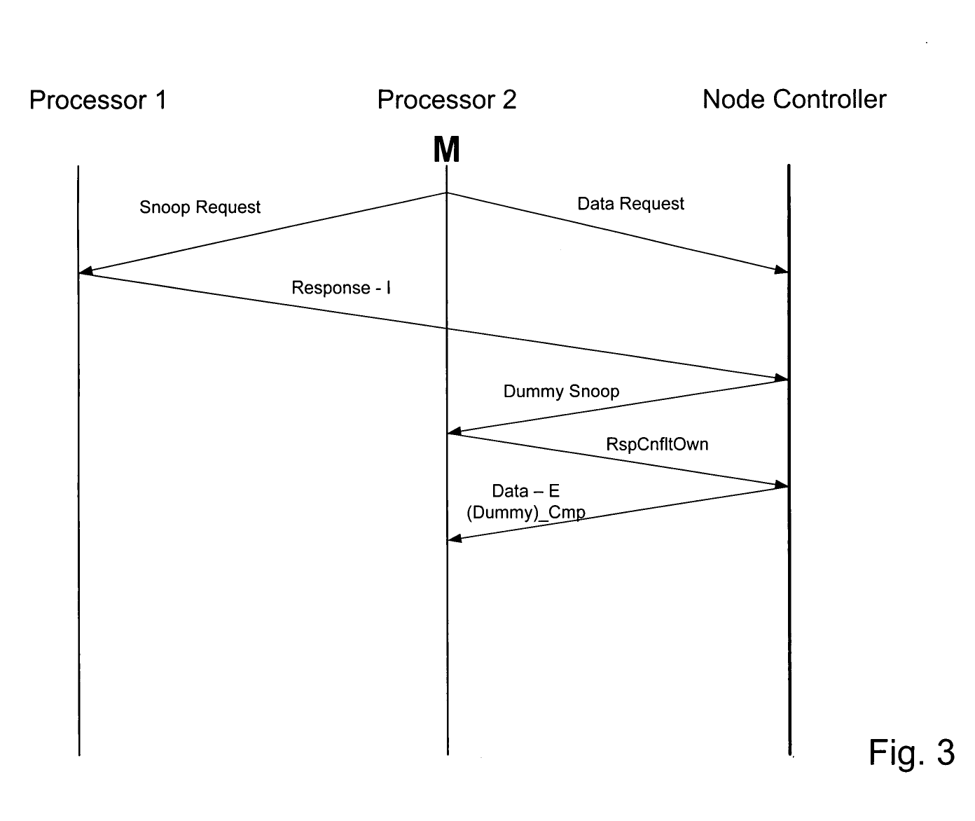

FIG. 3 is a conceptual illustration of a technique to resolve a Buried HitM condition. In the example of FIG. 3, two processors and a node controller are illustrated; however, any number of processors may be included in a cluster with a node controller, or multiple nodes may be represented by the respective node controllers in a hierarchical architecture, an example of which is provided below.

Processor 2 may be in need of a block of data that is stored in a cache (e.g., a L3 cache) associated with Processor 2. If a Buried-M condition exists (as illustrated by the “M”by Processor 2, Processor 2 may request the block of data by sending a Data Request message to the node controller and a Snoop Request message to Processor 1. Processor 1 may respond to the Snoop Request message with a Response message to the node controller. The Response message may indicate whether Processor 1 has a copy of the requested data and the state of the data (e.g., Modified, Invalid).

In one embodiment, in response to receiving the Data Request message from Processor 2, the node controller may access the snoop filter to determine whether any node in the cluster has a cached copy of the requested data. In the example of FIG. 3, Processor 2 has a copy of the requested data in a cache memory. Because the Data Request message originated from Processor 2, the node controller may transmit a Dummy Snoop message to Processor 2.

If the node controller did not have the snoop filter, in response to the Data Request message the node controller would send a data request to the home node corresponding to the requested data. In one embodiment, the home node is the node having non-cache memory corresponding to the requested data. In general, a data request to a home node incurs greater latency than acquiring the requested data from local, cached sources. Thus, if the node controller can determine that the data is available locally and avoid requests to the home node overall system performance may be improved.

In one embodiment, the Dummy Snoop message to Processor 2. The Dummy Snoop message may indicate the node controller as the snoop requester. The Dummy Snoop message may operate to verify that Processor 2 does have a copy of the requested data. In response to the Dummy Snoop message, Processor 2 may transmit a Response Conflict Own (RspCnfltOwn) message to the node controller.

In response to receiving the Response Conflict Own message, the node controller may send a Exclusive Data with Completion (DataE(Dummy)_Cmp) message. This message may give Processor 2 ownership of the requested data a signal completion of the data acquisition cycle started by the Data Request message from Processor 2.

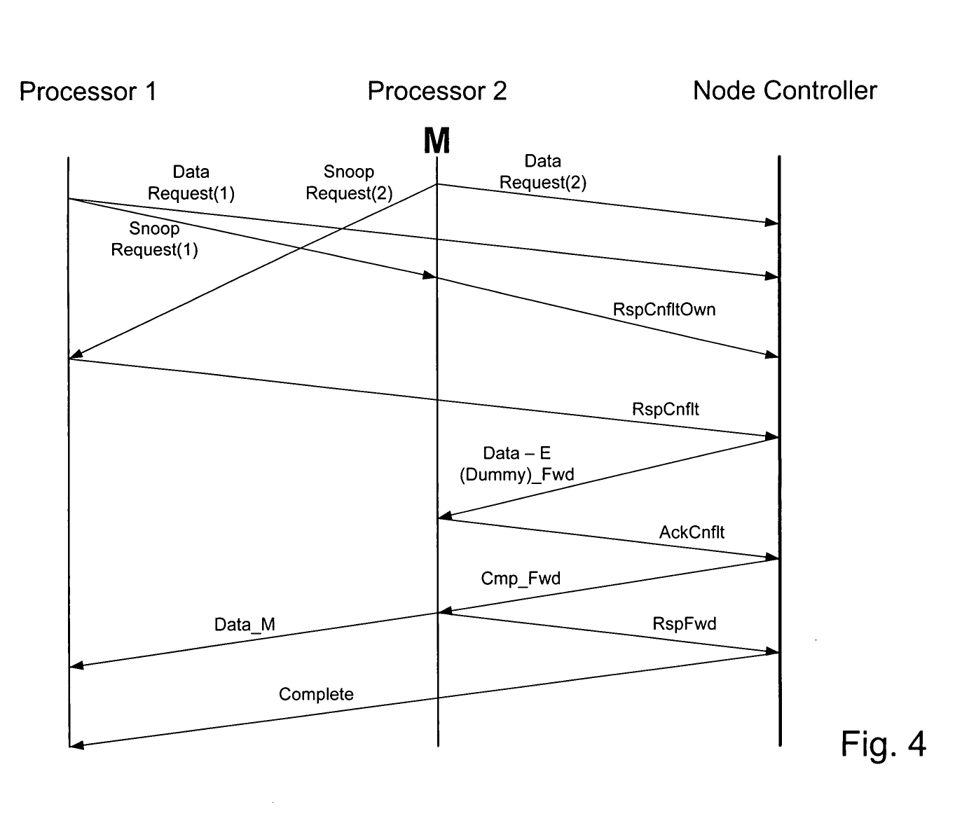

FIG. 4 is a conceptual illustration of a technique to resolve a Buried HitM condition when two processors request the data. As with the example of FIG. 3, in the example of FIG. 4 two processors and a node controller are illustrated; however, any number of processors may be included in a cluster with a node controller, or multiple nodes may be represented by the respective node controllers in a hierarchical architecture, an example of which is provided below. In the example of FIG. 4 both processors request the same block of data.

Processor 2 may be in need of a block of data that is stored in a cache (e.g., a L3 cache) associated with Processor 2. If a Buried-M condition exists (as illustrated by the “M” by Processor 2, Processor 2 may request the block of data by sending a Data Request(2) message to the node controller and a Snoop Request(2) message to Processor 1. Before Processor 2 acquires the requested data, Processor 1 may request the same block of data by sending a Data Request(1) message to the node controller and a Snoop Request(1) message to Processor 2.

When the node controller receives the Data Request(2) message the node controller may determine, via the snoop filter, that Processor 2 has a cached copy of the requested data. Similarly, when the node controller receives the Data Request(1) message, the node controller may determine, via the snoop filter, that Processor 2 has a cached copy of the requested data. In response to receiving the Snoop Request(1) message Processor 2 identifies a conflict and sends a RspCnfltOwn message to the node controller. In response to receiving the Snoop Request(2) message Processor 1 also identifies a conflict and sends a Response Conflict (RspCnflt) message to the node controller.

Because of the conflicting requests for the block of data, the node controller may send a DataE Forward (DataE(Dummy)_Fwd) message to Processor 2. This message may give Processor 2 ownership of the requested data and indicate that the data should be forwarded after the data is used. Processor 2 may respond with a Conflict Acknowledge (AckCnflt) message to the node controller. Upon receiving ownership of the requested data Processor 2 may perform the operation(s) for which the block of data was requested.

The node controller may then send Processor 2 a Complete-Forward (Cmp_Fwd) message to indicate completion of the data acquisition cycle started by the Data Request message from Processor 2 and that Processor 2 should forward the data to Processor 1 when finished using the data. Processor 2 may forward the data to Processor 1 with a Data Modified (Data_M) message.

Processor 2 may indicate to the node controller that the requested data has been forwarded with a Response Forward (RspFwd) message. In response to the RspFwd message, the node controller may send a Complete (Cmp) message to Processor 1 to signal completion of the data acquisition cycle started by the Data Request message from Processor 1.

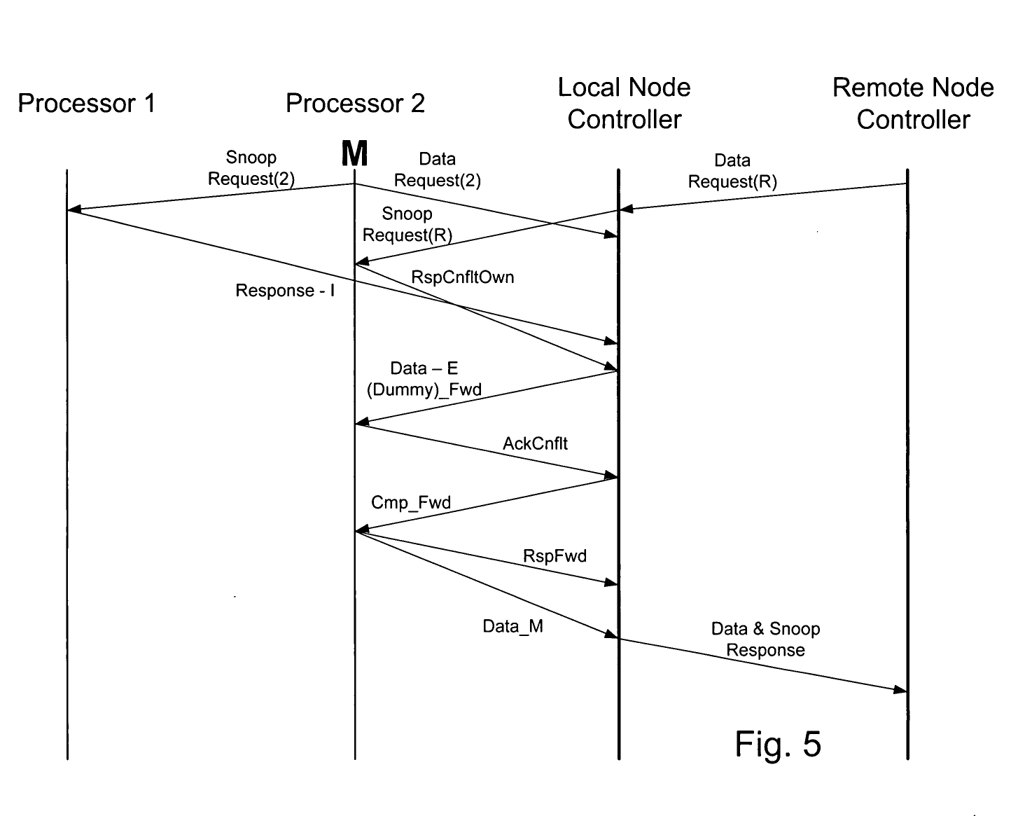

FIG. 5 is a conceptual illustration of a technique to resolve a Buried HitM condition when a conflicting request is received from a remote node controller. In the example of FIG. 5 two processors and a node controller are illustrated where a local node controller may communicate with a remote node controller; however, any number of processors may be included in a cluster with the local node controller and the local node controller may be coupled with any number of remote node controllers.

Processor 2 may be in need of a block of data that is stored in a cache (e.g., a L3 cache) associated with Processor 2. If a Buried-M condition exists (as illustrated by the “M” by Processor 2, Processor 2 may request the block of data by sending a Data Request(2) message to the local node controller and a Snoop Request(2) message to Processor 1. Before Processor 2 acquires the requested data, a remote node controller may request the same block of data by sending a Data Request(R) message to the local node.

When the local node controller receives the Data Request(2) message the local node controller may determine, via the snoop filter, that Processor 2 has a cached copy of the requested data. Similarly, when the local node controller receives the Data Request(R) message from the remote node controller, the local node controller may determine, via the snoop filter, that Processor 2 has a cached copy of the requested data. In one embodiment, the local node controller may wait until one or more Snoop Response messages are received before sending a subsequent message related to the Data Request(2) and Data Request(R) messages.

In response to receiving the Snoop Request(R) message Processor 2 may identify a conflict and send a RspCnfltOwn message to the node controller. Processor 1 may respond to the Snoop Request(2) message with a Response message to the local node controller. The Response message may indicate whether or not Processor 1 has a copy of the requested data and the state of the data (e.g., Modified, Invalid).

Because of the conflicting requests for the block of data, the local node controller may send a DataE Forward (DataE(Dummy)_Fwd) message to Processor 2. This message may give Processor 2 ownership of the requested data and indicate that the data should be forwarded after the data is used. Processor 2 may respond with a Conflict Acknowledge (AckCnflt) message to the local node controller. Upon receiving ownership of the requested data Processor 2 may perform the operation(s) for which the block of data was requested.

The local node controller may then send Processor 2 a Complete-Forward (Cmp_Fwd) message to indicate completion of the data acquisition cycle started by the Data Request message from Processor 2 and that Processor 2 should forward the data to the local node controller when finished using the data. Processor 2 may indicate to the node controller that the requested data will be forwarded with a Response Forward (RspFwd) message.

Processor 2 may forward the data to the local node controller with a Data Modified (Data_M) message. When the local node controller receives the forwarded data from Processor 2, the local node controller may send the requested data and a Snoop Response message to the remote node controller. The remote node controller may then send the requested data to the requesting entity.

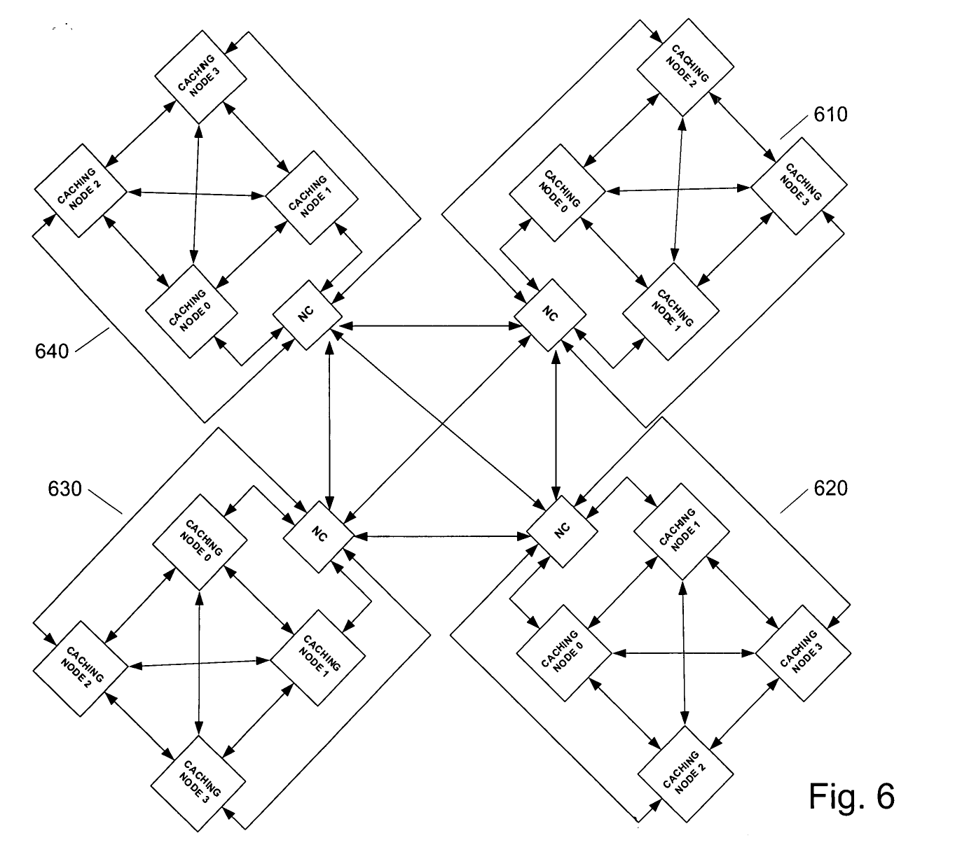

FIG. 6 is a block diagram of a hierarchical system having multiple node controllers. FIG. 6 illustrates an example architecture of interconnecting four node controllers with their corresponding caching agents. In one embodiment, the node controllers may interact utilizing the same messaging protocol as is used between the caching agents.

In one embodiment, each cluster (610, 620, 630, 640) is configured similarly to the cluster of FIG. 1 where a group of caching nodes are interconnected via point-to-point links with a node controller. The node controllers may also be interconnected via point-to-point links. This allows a node controller to represent a group of caching agents to a larger system in a hierarchical manner. The architecture may be further expanded by including a node controller to represent clusters 610, 620, 630 and 640 to other groups of clusters.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

While the invention has been described in terms of several embodiments, those skilled in the art will recognize that the invention is not limited to the embodiments described, but can be practiced with modification and alteration within the spirit and scope of the appended claims. The description is thus to be regarded as illustrative instead of limiting.

What is claimed is:

1. A method comprising:
detecting a request for a block of data from a processor with a node controller, wherein the node controller operates as a single point of interaction to represent a subset of processors in a multi-processor system to one or more remote processors in the multi-processor system;
determining whether the block of data corresponds to an entry in a snoop filter maintained by the node controller, wherein the snoop filter stores indications for a plurality of blocks of data stored in one or more cache memories corresponding to the subset of processors; and
sending a dummy snoop request to the requesting processor if the block of data corresponds to an entry in the snoop filter.

2. The method of claim 1 further comprising transmitting the request to the one or more remote processors if the block of data does not correspond to and entry in the snoop filter.

3. The method of claim 1 further comprising causing the requesting processor to forward the block of data in response to detecting a conflicting request for the block of data.

4. The method of claim 3 wherein the conflicting request is received from one of the subset of processors.

5. The method of claim 3 wherein the conflicting request is received from a remote node controller that represents one of the remote processors.

6. The method of claim 1 wherein the node controller is coupled with the subset of processors to transmit the requests and responses over a plurality of point-to-point links.

7. An apparatus comprising:
a group of two or more local caching agents, each having one or more cache memories;
a local node controller coupled with the group of local caching agents, wherein the local node controller has a snoop filter to store indications for a plurality of blocks of data stored in one or more cache memories corresponding to the two or more local caching agents, wherein the local node controller detects a request for a selected block of data from one of the local caching agents, determines whether the selected block of data corresponds to an entry in the snoop filter maintained by the node controller, and sends a dummy snoop request to the requesting caching agent if the selected block of data corresponds to an entry in the snoop filter.

8. The apparatus of claim 7 wherein the group of two or more local caching agents are interconnected with each other via point-to-point links.

9. The apparatus of claim 7 wherein the group of two or more local caching agents comprises at least one processor.

10. The apparatus of claim 7 wherein the group of two or more local caching agents comprises at least one memory controller.

11. The apparatus of claim 7 wherein the node controller further transmits the request to a remote caching agent if the selected block of data does not correspond to and entry in the snoop filter.

12. The apparatus of claim 7 wherein the node controller causes the requesting caching agent to forward the selected block of data in response to detecting a conflicting request for the selected block of data.

13. The apparatus of claim 12 wherein the conflicting request is received from one of the local caching agents.

14. The apparatus of claim 12 wherein the conflicting request is received from a remote node controller that represents one or more remote caching agents.

15. A system comprising:
a group of two or more local caching agents, each having one or more cache memories, each of the local caching agents coupled with a dynamic random access memory;
a local node controller coupled with the group of local caching agents, wherein the local node controller has a snoop filter to store indications for a plurality of blocks of data stored in one or more cache memories corresponding to the two or more local caching agents, wherein the local node controller detects a request for a selected block of data from one of the local caching agents, determines whether the selected block of data corresponds to an entry in the snoop filter maintained by the node controller, and sends a dummy snoop request to the requesting caching agent if the selected block of data corresponds to an entry in the snoop filter.

16. The system of claim 15 wherein the group of two or more local caching agents are interconnected with each other via point-to-point links.

17. The system of claim 15 wherein the group of two or more local caching agents comprises at least one processor.

18. The system of claim 15 wherein the group of two or more local caching agents comprises at least one memory controller.

19. The system of claim 15 wherein the node controller further transmits the request to a remote caching agent if the selected block of data does not correspond to and entry in the snoop filter.

20. The system of claim 15 wherein the node controller causes the requesting caching agent to forward the selected block of data in response to detecting a conflicting request for the selected block of data.

21. The system of claim 20 wherein the conflicting request is received from one of the local caching agents.

22. The system of claim 20 wherein the conflicting request is received from a remote node controller that represents one or more remote caching agents.
